(19) United States
(12) Patent Application Publication
(10) Pub. No.: US 2012/0205331 A1
(43) Pub. Date: Aug. 16, 2012

(54) Modular Candle Stacks

(76) Inventors: Cindy Stejskal, Larned, KS (US); Audrey Miller, McPherson, KS (US)

(21) Appl. No.: 13/274,614

(22) Filed: Oct. 17, 2011

Related U.S. Application Data
(60) Provisional application No. 61/442,362, filed on Feb. 14, 2011.

(51) Int. Cl. F21V 35/00; F21V 21/00; F16M 11/20

(52) U.S. Cl. 211/60.1; 248/188.1; 248/176.3

(57) ABSTRACT

A modular candle holder or support device for custom design and assembly by a user. A plurality of decorative modular units having specific designs and shapes can be combined to build unique support stacks, which may be utilized as candlestick holder, lamp supports or similar vertical support devices. To connect the modular units, each unit is equipped with at least one internally and female-threaded opening to receive a double-ended, male-threaded connector piece. The double-ended male-threaded connectors join two modular units together in series. The components can be combined in numerous variations to form different style holders and ornamental configurations. In additional to holding candles, the elements of the invention may be utilized to create light holders, flower holders, or individual modular units that can stand alone as a napkin ring or tea light candle holder.

### CROSS REFERENCE TO RELATED APPLICATION

This application claims the benefit of U.S. Provisional Application No. 61/442,362 filed on Feb. 14, 2011, entitled “Candle Stacks.”

### BACKGROUND OF THE INVENTION

1. Field of the Invention

The present invention relates to home décor and decorative displays. More specifically, the present invention pertains to a new decorative assembly of modular units that form together to create unique candle holder designs. Multiple modules can be arranged in a variety of displays for holding candle sticks and flowers, while a single module standing alone could serve as a decorative napkin ring.

2. Description of the Prior Art

Many individuals enjoy the aesthetics associated with candles in the home. Some also use candle lighting as a secondary form of lighting or for creating a romantic atmosphere. Candles are typically held individually by a candle stick, or are configured in groups and held by a candelabrum. Candelabra are large, decorative candle holders with a center shaft and geometric configuration branching outwards from the center shaft. Candelabra often take up a large amount of space. They are beautiful, but bulky, and their size is sometimes an inconvenience and/or impractical. On the other hand, candle sticks holders are smaller, as they can only hold one candle at a time, and can vary in height. Candle stick holders can fit into a larger number of spaces than a candelabrum practically can.

Seasonal changes, decorating trends, the demands of various holidays or family events, and even a user's whim can create the need for new and different home decorating items. This need for variety has, in the past, required an extensive assortment of single-function items such as table centerpieces, formal napkins and dinner table placemats, vases and candle holders. The problem associated with home décor is that the items used for decorating the home are typically single function items, which require storage when not in use. If some of these home décor items could serve multiple functions, it could eliminate the storage challenges and high cost associated with having a variety of single-function home décor items. Multifunctional home décor items would be a more efficient, versatile, and a cost-effective solution.

Several applications have published and patents have been granted to candle holding devices that comprise multiple modules that can be arranged into displays that meet the user's preference. However, no patents were found that describe the structural elements of the present invention. The most relevant article of prior art found includes a modular candle holder that has several components for assembling a candle holder of various different designs. However, when viewed in detail, this device is easily distinguishable from the present invention. Other prior art patents reported below are also considered, and relate to modular candle holders that may be assembled in different fashions.

U.S. Pat. No. 6,120,283 to Cousins describes a modular candle holder comprising of two parts; a top piece and a bottom piece. The top piece is designed to be interchangeable with other top pieces capable of receiving different candles with a variety of candle base diameters. The versatility of this device is limited to only two components. The height of the device cannot be adjusted beyond the height achieved by combining a top piece with a bottom piece. The present invention allows for a great degree of variety in style and height as the user can attach as many or as few modular units in a row to achieve the desired candle stick holder height.

U.S. Patent Application, Publication No. 2004/0040923 to Wolff describes a system of modular holders for creating arrays of candle holders. Each modular holder is the skeletal frame of a cube and has a circular ring set into the top face of the modular cube. The ring serves as a holder for a candle, a candle dish or flowers, and also designates the top of the modular holder. Each modular holder has four short legs protruding from the bottom face of the cube shaped modular holder, opposite the top cube face with the ring in it. These legs are octagonal in shape. On the top cube face with the ring in it, there are holes at each corner of the cube face. These holes are octagonal in shape and receive the legs of another modular holder so that a number of modular holders can be stacked together to form an array for displaying candles. The arrays can be arranged in a myriad of ways based on the user's preferences. The arrays can be arranged so the display has a single line base with more modular units stacked upward, or the arrays can be arranged so that the display exists in a three dimensional space. The possible design combinations of these modular units are endless.

Similarly, U.S. Pat. No. 6,634,513 to Hardy also describes a system of modular holders for creating arrays of candle holders that have interlocking parts. The Hardy device describes various shaped candle holders, each with a number of candle receiving wells to place a candle in, which can be arranged into displays. Each candle holder is made up of a number of candle receiving wells, which are small square cups that a candle can be placed in. For example, a modular unit could be a series of three candle receiving wells in a single, linear row or four candle receiving wells arranged in a two by two square. Various modular shapes could exist. The modules can be arranged into various configurations and arrays. The modules are interlocking. Each candle receiving well on its bottom side has a small, square shaped base. When a first module is stacked on top of a second module, the candle receiving well base of the first module fits inside of the candle receiving well of the second module that it is stack on top of. The Hardy device can be arranged to form three dimensional display arrays for candles.

U.S. Pat. No. 7,036,954 to Cordle describes a candle holder assembly having a base and an extendable base shaft with a narrow candelabrum, similar to a menorah, situated on top of the base shaft. The base shaft is extendable by screwing together extension members. The height of the device can be adjusted depending on how many extension members are used. The extension members are modular and are not decorative but have small holes that are designed to receive the stems of decorative flowers or other decorative accoutrements. The candelabra may have multiple holding wells for the candle sticks and is not modular in its construction; the number of candle holding wells in the candelabra is fixed and additional wells cannot be added to the device. However, other menorah-like candelabra configurations with more or fewer candle holding wells are available for use and can be attached to the top of the base shaft of the device.

The Cordle patent describes multiple variations of its preferred design, but each embodiment describes a plurality of candle holding wells. While the device could be equipped with just a single candle stick placed in one of the menorah-like candelabra candle holding wells, the device takes up the space of a candelabrum. Furthermore, the space consumption associated with the use of the Wolff, Hardy and Cordle devices may be undesirable to a user in certain situations. The present invention is a single candle stick holder, which takes very little space at its base.

U.S. Pat. No. 2,898,755 to Josephson describes a modular candle holder that can be assembled into a candelabrum. The device consists of several artistically-styled vertical members. Some of the modular vertical members have a position wherein a candle stick or similar decorative element may be seated, while other vertical members consist of only decorative elements. The vertical members combined in various configurations by connecting the members to a center point through a series of vertical slots. A center piece serves as the center of the device, which has a series of grooves to receive the verticals slots of each vertical member. A user can choose a multitude of decorative configurations of the candelabra. The device fills a three dimensional space and while holding multiple candle sticks, the decorative nature of the fully constructed device takes up considerable space. The Josephson device can only be used in an open space because of its size.

It is apparent that the present invention substantially diverges in design elements from the prior art and, consequently, it is clear that there is a need in the art for an improvement to existing single function home décor items, to convert them into multifunction home décor items. In this regard the instant invention substantially fulfills these needs.

### SUMMARY OF THE INVENTION

In view of the foregoing disadvantages inherent in the known types of decorative, modular candle holder devices now present in the prior art, the present invention provides a new decorative and modular candle stick holder, wherein the same can be utilized to provide the user with a creative way to create his or her own custom-designed candle stick holder or flower holder. This device serves as a multifunctional home décor device.

It is therefore an object of the present invention to provide a new and improved decorative candle stick holder device that has all of the advantages of the prior art and none of the disadvantages.

Another object of the present invention to provide users with a new way to create their own custom-designed candle stick holder from modular components, providing users with a plurality of configurations for a candle stick holder to meet a given preference.

Another object of the present invention is to provide users with a cost effective decorative means that can easily be modified to meet changing home décor trends.

Yet another object of the present invention is for the device to serve as a multi-functional device, serving various home décor purposes.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective exploded view of the present invention, and how it can be assembled.

FIG. 2 is a perspective cross sectional view of a single modular unit from the present invention

FIG. 3 is a perspective view of the present invention fully assembled.

### DETAILED DESCRIPTION OF THE INVENTION

Reference is made herein to the attached drawings. Like reference numerals are used throughout the drawings to depict like or similar elements of the candle holder device. For the purposes of presenting a brief and clear description of the present invention, the preferred embodiment will be discussed as used for providing a modular and customizable candle holder device. The figures are intended for representative purposes only and should not be considered to be limiting in any respect.

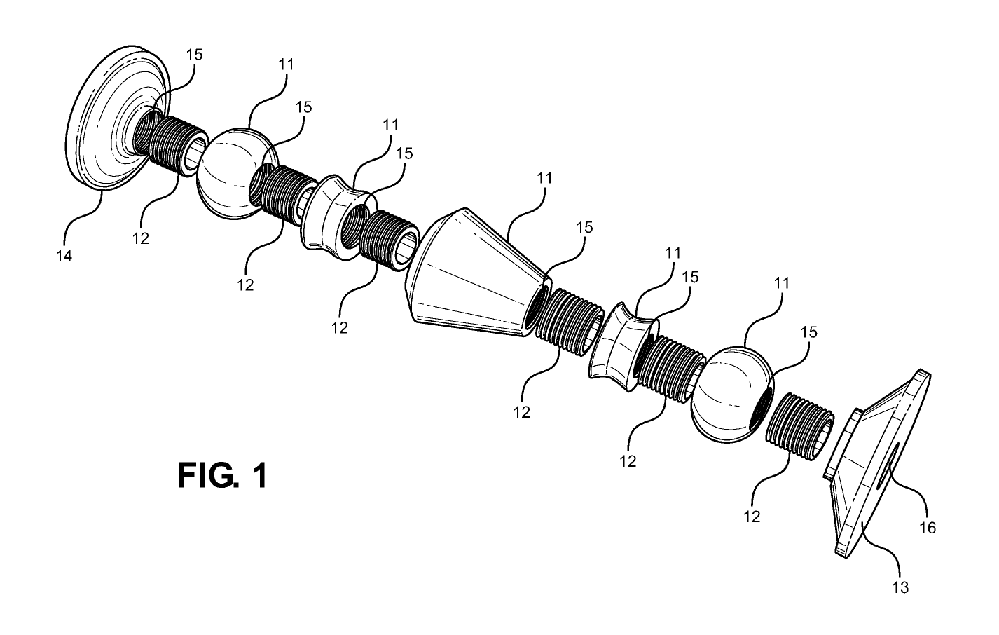

Referring now to FIG. 1, there is shown an exploded perspective view of a typical configuration of the disclosed device as described by the present invention, wherein a plurality of modular units 11 are connected together via double-ended, male-threaded connectors 12 to form a continuous candle holder device. When assembling the device, a candle holding modular unit is attached as the upper-most unit 13 and a base unit is attached as the base unit 14. Based on the user's preferences, the user may select different decorative modules 11, how many modules and what order to place those modules between the candle holder 13 and the base unit 14. Each unit comprises a first and second threaded aperture, adapted to accept a male-threaded connector 12, which joins two units together in series. A variety of shapes, sizes, colors and styles may be adorned on each unit, while the sequence and size of the units may conform to a user's particular tastes or a specific event. The modular units 11 may be comprised of any suitable material, including resin, plastic, wood or a metallic material. The desired material may further be coated to have different finishes to provide different colors, textures and appearance for each.

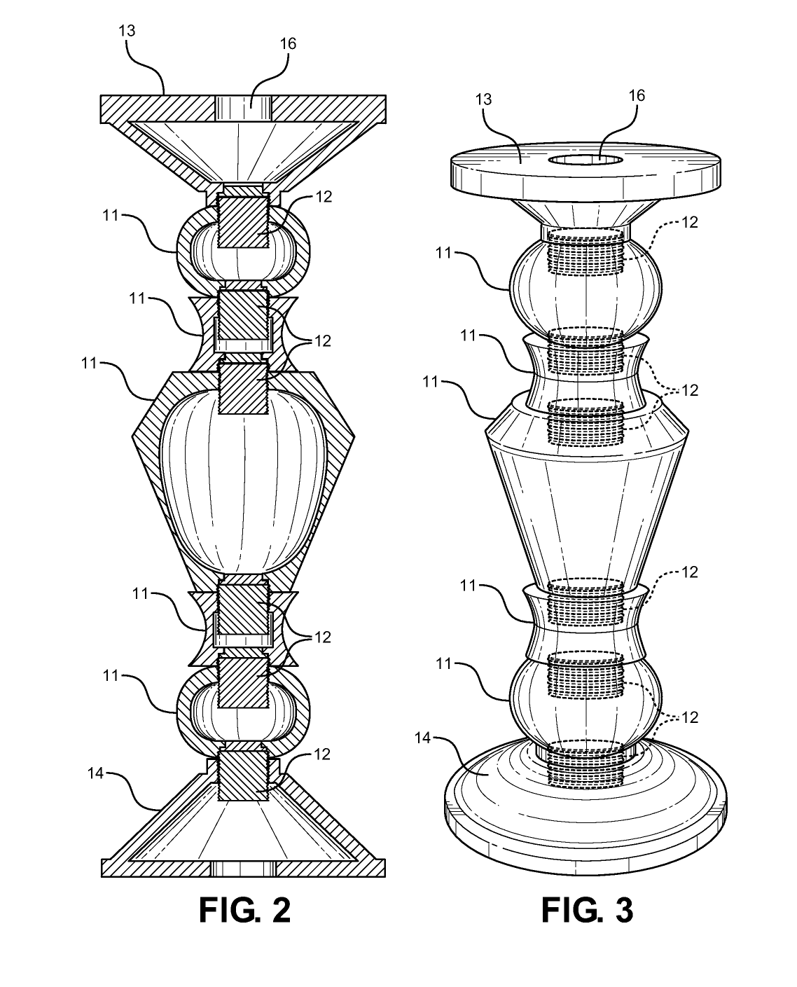

Referring now to FIG. 2, there is shown a cross sectional side view of a particularly configuration of the disclosed device as described by the present invention. The modular units 11 are screwably fixed together, end-to-end, such that they appear to be stacked on top of one another and form a continuous structure that does not appear to be decomposable or reconfigurable. Each modular unit 11 has two female-threaded openings 15, one located on either end of the unit. These female-threaded openings 15 are designed to receive a male-threaded end of a double-ended, male-threaded connector 12, therefore allowing connection of two units 11 to a single threaded connector 12. As stated, the number of units, their design and the order in which they are configured may be designed by the user, allowing for a reconfigurable and modular article that may function as a candle holder or candelabra.

Referring now to FIG. 3, there is shown a perspective view of the full assembled device. The device shown is a candle stick holder version of the device. When the device is fully assembled, no visual signature is provided that indicates the device is comprised of a series of modular units 11, as the final configuration of modules appears to be a candle stick holder of solid construction. While the figures to this point have shown the device as a candlestick holder, the device and units thereof may be adapted for use in multiple functions. The device may also serve as a vase to hold flowers or can be combined with the light building kit to create a custom-made lamp. The upper portion 13, in these instances, is adapted to hold flowers or support a light bulb and lamp shade, as opposed to a candlestick. This upper portion 13 may be modified to suit a number of purposed, as well as the base may be modified to support heavier or taller loads by providing different width and weight base units 14.

The present invention may be provided in kit form, wherein its constituent units are provided, along with their connector units, in a specified design or number to allow for a specific occasion or style. The user can choose the overall size and how elaborate to construct the plurality of units from the kit. Alternatively, modular units may be purchased individually to allow personalized designs to be produced by a user. The distribution of the present invention is not desired to be limited to a specified kit, but rather its modular construction and functionality is alternatively considered primary to its utility. In use an individual chooses which modular pieces from which to utilize in constructing a personalized candlestick holder that satisfies his or her preferences. The user selects the desired combination of decorative modular units, and assembles the end configuration as desired. Each modular unit has two female-threaded openings; one on the top face of the unit and one on the bottom face of the unit. A user connects the modular units to one another by screwing into the female-threaded opening to a first end of a double-ended, male-threaded connector. The second end of the double-ended, male-threaded connector is then screwed into another female-threaded opening on another module unit to create a series of units securably attached together.

In addition to the stacking feature of the present device, an assortment of top and base units are contemplated for accommodating different sized and functional devices. These include, but are not limited to, a lamp kit, a cake plate, or any similar holder or support device that would benefit from a decorative and vertical support as its base. The present invention is multifunctional and can be used for holding candles, flowers, lamps, cakes or any other suitable article. Additionally, the individual modules, when not connected to one another to form a support device, can be used for holding individual tea light candles, or could serve as decorative napkin rings. The apertures through each unit allow their use as individual components when not connected in series by the aforementioned double-ended male screw connector.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vertical support device that provides unique ornamental configurations and functions as desired by a user, comprising:
a plurality of modular units and connector pieces;
said modular units having a decorative outer design and shape, said units having a first and second opening for receiving said connector pieces;
said connector pieces adapted to connect to two modular units, joining said units in series;
a top-most modular unit for supporting an article thereabove;
a bottom-most modular unit serving as a base for said device;
said top-most modular unit having an opening at its base for receiving a connector piece
said bottom-most modular unit having an opening at its upper for receiving a connector piece.

2) The device of claim 1, wherein said modular unit openings comprise a female-threaded opening, said connector pieces comprising a double-ended, male-threaded connector adapted to secure mate with said female-threaded openings.

3) The device of claim 1, wherein said modular units are comprised of a resin construction and coated with an outer surface finish.

4) The device of claim 1, wherein said top-most modular unit comprises an aperture along an upper surface, designed to support a candlestick.

5) The device of claim 1, wherein said top-most modular unit comprises a plurality of candle supporting structures that form a candelabrum.

6) The device of claim 1, wherein said top-most modular unit is adapted to support a light fixture and lamp shade.

7) The device of claim 1, wherein said top-most modular unit comprises a flat plate and is adapted to support an article thereon.
